(19) United States
(12) Patent Application Publication
(10) Pub. No.: US 2002/0048496 A1
(43) Pub. Date: Apr. 25, 2002

(54) Spreader dowel

(76) Inventor: Horst Filipp, Enger-Oldinghausen (DE)

Correspondence Address: HENRY M FEIEREISEN, 350 FIFTH AVENUE, SUITE 3220, NEW YORK, NY, 10118

(21) Appl. No.: 09/977,451

(22) Filed: Oct. 15, 2001

(30) Foreign Application Priority Data
Oct. 24, 2000 (DE) 100 52 662.4

(51) Int. Cl. F16B 13/06

(52) U.S. Cl. 411/55

(57) ABSTRACT

A dowel includes a dowel component having at least one longitudinal slot and formed with a cylindrical internal thread; and a spreader screw for threaded engagement in the internal thread of the dowel component. The internal thread has at least one expansion zone defined by a thread diameter which is constantly smaller than the thread diameter of the spreader screw, wherein the expansion zone has a thread pitch which is the same as a thread pitch of the spreader screw.

### CROSS-REFERENCES TO RELATED APPLICATIONS

This application claims the priority of German Patent Application Serial No. 100 52 662.4, filed Oct. 24, 2000, the subject matter of which is incorporated herein by reference.

### BACKGROUND OF THE INVENTION

The present invention relates, in general, to a spreader dowel, and more particularly to a dowel of a type having a dowel component with at least one longitudinal slot and an internal thread for threaded engagement of a spreader screw.

It is to be understood by persons skilled in the art that the term “spreader dowel” is used in the following description in a generic sense and refers to any expansible connector, which generally follows the concepts outlined here, including those connectors also referred to as “expansible anchors” or “expansible plugs”.

Dowels of this type are widely used for many applications. For example, dowels can be used to secure fittings such as door handles or the like. Generally, the use of such dowels is fairly limited and inappropriate for many applications, so that separate constructions, which are oftentimes expensive, become necessary. Examples include the attachment of curved handles on both sides of a door leaf, especially door leaves of safety glass. In these cases, bolts are routed through the door and pinned together with the door handles on opposite sides of the door.

Other constructions propose to rotate stud screws laterally into a handle for engagement in a circumferential groove of a coupling piece which is connected to the bolt and inserted in the door handle.

Apart from their relatively complex structure and limited field of application, a feature that is common to all conventional dowel constructions is their limited capability to withstand loads. In particular, when used in door handles, which typically are exposed to tensile stress, the mounting becomes loose and requires necessary maintenance works. Not only are the costs increased, but a loose door handle is also annoying to the user, in particular in the commercial field, when encountered, for example, in entrance doors to shops.

The use of metallic spreader dowels is also known for securement of fittings to door or window frames. The spreader dowels include a sleeve having one end in which a cone is drawn in by means of an inserted screw to thereby spread the slotted end zone of the sleeve and to establish a union with the attached fittings. These types of dowels suffer also shortcomings as far as a secure hold of the fitting is concerned, especially when the door or window frame is subjected to significant and ongoing stress. As a frictional engagement and a partial positive engagement as a result of the rough surface of the expanded zone is effective only along a short distance, commensurate with the expansion effected by the cone as it is drawn in, tensile forces cannot be continuously absorbed.

Problems relating to a sufficient securement of a fitting are encountered in particular when hollow sections are involved as window or door frames, with the expansion being effective behind a wall or at the intrados of a bore formed in the wall for the dowel. Moreover, as the cone is drawn in into the sleeve, this wall and/or the outside wall of the frame, upon which the sleeve with an attached collar bears, may buckle as a consequence of encountered pressure forces and thus not only adversely affects the stability but also the optical appearance, especially in the visible area of the outer frame wall.

In order to overcome these shortcomings of conventional dowels, proposals have been made to place fastening members within the hollow profile to exert a greater surface pressure upon the adjacent wall and to omit the use of a dowel altogether as the union is established exclusively through a clamping action. These fastening devices are also very complicated and difficult to install as they must be pushed into the hollow section. Apart from their cost-intensive fabrication, such fastening devices are very difficult to assemble and to dismantle.

It would therefore be desirable and advantageous to provide an improved dowel which obviates prior art shortcomings and is useable for many applications while still being easy to install and to dismantle and ensuring a safe attachment.

### SUMMARY OF THE INVENTION

According to one aspect of the present invention, a dowel includes a dowel component having at least one longitudinal slot and formed with a cylindrical internal thread; and a spreader screw for threaded engagement in the internal thread of the dowel component, wherein the internal thread has at least one expansion zone defined by a thread diameter which is constantly smaller than the thread diameter of the spreader screw, and wherein the expansion zone has a thread pitch which is the same as a thread pitch of the spreader screw.

A dowel according to the present invention is useable for a wide variety of different fittings relating not only to doors but also windows, and is able to absorb high loads as a result of its tight fit in the part with which it is connected. The novel and inventive dowel has a simple structure that allows easy and inexpensive fabrication and is easy to install in solid material, such as wood, bricks or porous concrete but also in hollow sections or perforated bricks.

According to another feature of the present invention, the spreader screw has a length which is shorter than the entire length of the internal thread. Suitably, the length of the spreader screw is the same or slightly shorter than the expansion zone. In this way, sufficient space remains to rotate a fastening screw into the remaining portion of the internal thread which has a thread diameter corresponding to the thread diameter of the spreader screw.

Suitably, the spreader screw has a diameter which corresponds to the diameter of the fastening screw. Of course, it is also conceivable to provide the spreader screw with a smaller thread diameter whereby care should be taken to so dimension the thread diameter of the spreader screw that is can still be reliably guided through the entire internal thread.

Basically, it is also conceivable to position the expansion zone of the internal thread inwardly of the base of a threadless bore in which, for example, a coupling piece can be placed, wherein the coupling piece has a circumferential annular groove for engagement of screws inserted laterally in a handle of a fitting so as to axially secure this handle.

As a consequence of the diametrical difference between the receiving portion for the spreader screw, on the one hand, and the spreader screw itself, on the other hand, an expansion is realized by the radially deflectable pressure-applying segments, which are formed by the provision of the longitudinal slots extending from the outer surface area of the dowel component up to the area of the internal thread, and which apply pressure over a fairly large area of the inside wall of the part which receives the dowel. The pressure application takes effect at least across the area that is defined by the length of the spreader screw.

However, the difference of the threads should not be too great, especially in those situations when the dowel is placed in a thin-walled part to avoid a deformation, when the expansion becomes excessive. Of course, the expansion is also defined by the extent the spreader screw is rotated in.

According to another feature of the present invention, the thread portion may be configured to have a smaller thread diameter substantially over the entire length of the dowel component, so that the dowel component is spread over the entire length by the spreader screw when the latter is rotated in. Hereby, longitudinal slots may extend from both ends of the dowel component, which are arranged in offset relationship and overlap one another. Of course, the provision of a single longitudinal slot is conceivable as well, which extends along the entire length of the dowel component.

The continuous expansion of the dowel results in a firm pressing against the intrados of the wall through which the dowel extends, whereby the pressing action is especially effective when the dowel component is formed along its outside with a thread that has flanks which penetrate the intrados to thereby implement a form-fitting engagement. Of course, instead of an external thread, it is also conceivable to profile the outer surface in a different manner, for example, through knurling or the like.

Besides the form-fitting engagement in the area of the intrados, the dowel bulges during expansion into the hollow space through which the dowel passes and immediately behind the last wall of the hollow profile. As the dowel bulges, its diameter becomes greater in this area compared to the throughbores confined by the walls and passed by the dowel to thereby realize a secure axial attachment of the dowel that is able to withstand even greatest loads. Tests have shown that although tensile forces may lead to a destruction or deformation of the hollow section, the dowel remains firmly in its anchoring.

The novel and inventive dowel can be anchored basically in any material. In particular, when wood is involved as material, the flanks of the external thread of the dowel penetrate deeply into the surrounding material.

A dowel according to the present invention is especially useful in situations when fittings should be replaced, as the spreader screw, carries the fitting or hardware, can easily be withdrawn, without modifying the mounted disposition of the dowel component. Subsequently, the spreader screw can be rotated again into the dowel component together with the new fitting.

In order to facilitate insertion and threaded engagement of the spreader screw, the expansion zone that has a smaller thread diameter than the remainder of the internal thread has an entry diameter which corresponds to the diameter of the spreader screw so that the spreader screw can reliably grip when rotated in. Following the entry diameter, the diameter of the expansion zone tapers in the predetermined extent.

### BRIEF DESCRIPTION OF THE DRAWING

Other features and advantages of the present invention will be more readily apparent upon reading the following description of a preferred exemplified embodiment of the invention with reference to the accompanying drawing, in which:

FIG. 1 is a partially sectional view of one embodiment of a dowel according to the present invention for connecting two handles to a door leaf;

FIG. 2 is a half section of a dowel component of the dowel of FIG. 1;

FIG. 3 is a longitudinal section of another dowel component of the dowel of FIG. 1;

FIG. 4 is a top plan view of the dowel component of FIG. 3;

FIG. 5 is a partially sectional side view of a half portion of another embodiment of a dowel according to the present invention;

FIG. 6 is a plan view of the dowel of FIG. 5;

FIG. 7 is a partially sectional, exploded side view of the dowel of FIG. 5; and

FIG. 8 is a partially sectional side view of the dowel in an installed state.

### DETAILED DESCRIPTION OF PREFERRED EMBODIMENTS

Throughout all the FIGURES, same or corresponding elements are generally indicated by same reference numerals.

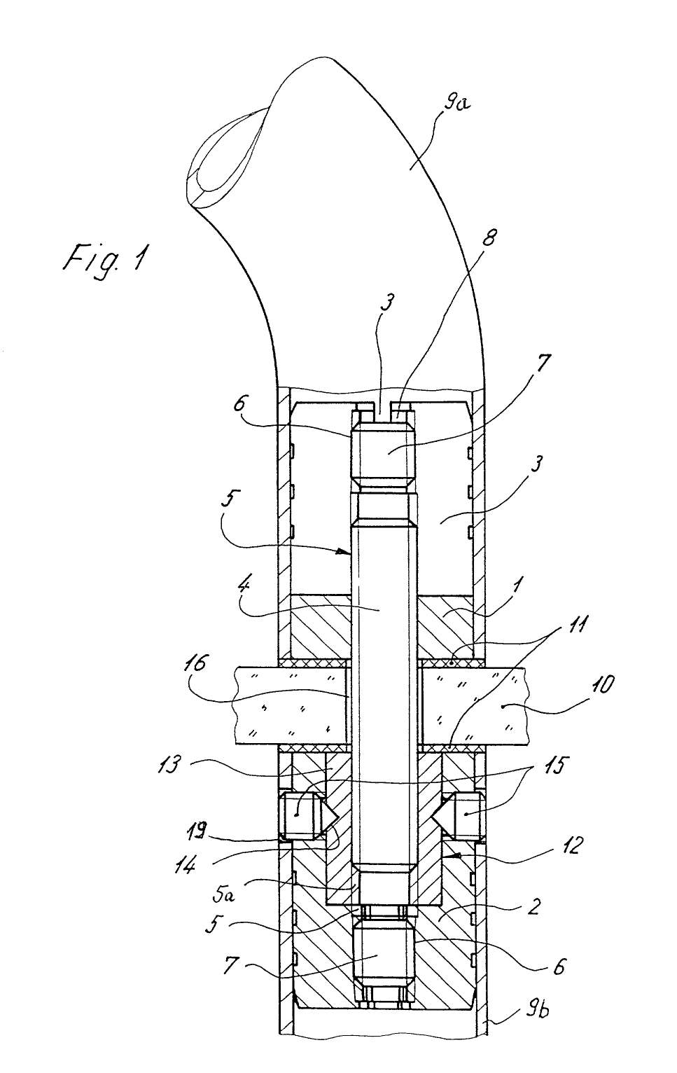

Turning now to the drawing, and in particular to FIG. 1, there is shown a partially sectional view of one embodiment of a dowel according to the present invention for connecting two curved handles 9a, 9b to a door leaf 10, whereby the handles 9a, 9b are arranged on opposite sides of the door leaf 10 and made of a relatively thin-walled tube, for example of light metal. Disposed between each of the handles 9a, 9b and an associated support surface of the door leaf 10 is a pane 11, whereby the panes 11 and the door leaf 10 define together a throughbore 16.

The dowel is comprised of a first dowel component 1 which has a generally cylindrical configuration and is placed within the handle 9a by insertion through the open, leaf-proximal side of the handle 9a. Along its outer surface area, the dowel component 1 may be profiled, for example, knurled or fluted, as shown. The dowel component 1 is inserted in such a manner as to terminate flush with the end face at the open side of the handle 9a, and includes a cylindrical internal thread 5 for threaded engagement of a fastening screw 4. Extending in axial direction from its leaf-distal end 17, the dowel component 1 has four longitudinal slots 3 which are spaced from one another at a same angular distance, as shown in particular in FIG. 4, to thereby define radially deflectable segments 18. The longitudinal slots 3 extend from the perimeter of the dowel component 1 radially inwardly up to the internal thread 5 and in axial direction from the end along a suitable length to leave sufficient material to ensure secure fit of the fastening screw 4.

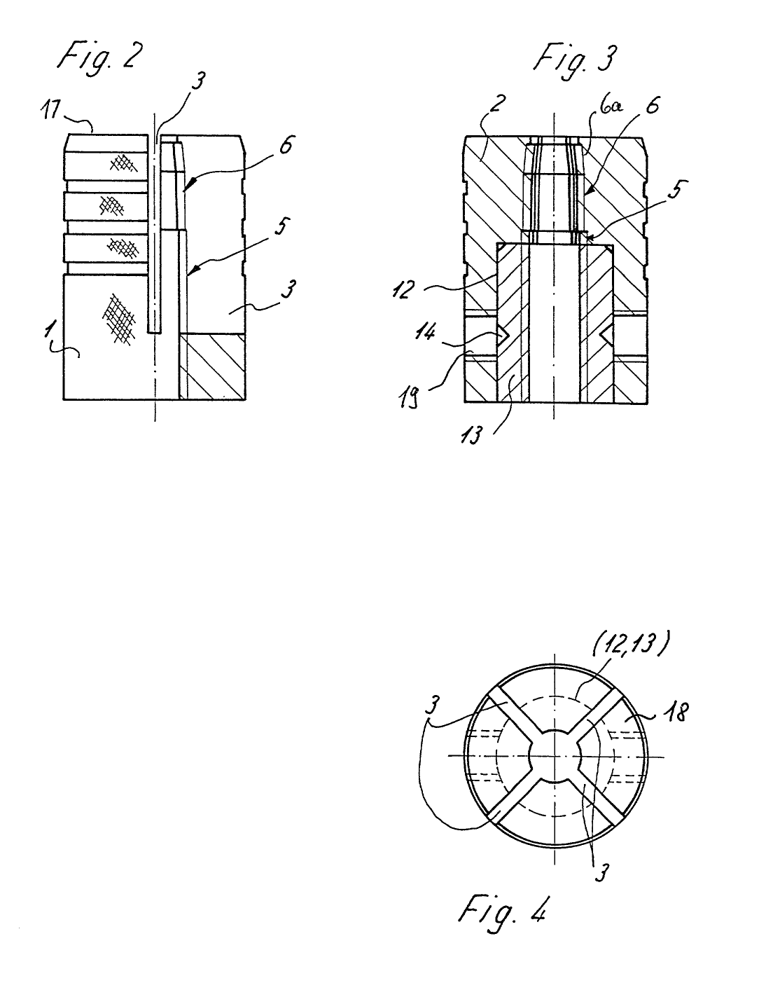

At its end distal to the entry side of the dowel component 1 into the handle 9a, the internal tread 5 has an expansion zone 6 for interaction with a spreader screw 7, which has a thread diameter that is greater than the thread diameter, i.e. nominal diameter, of the expansion zone 6 of the internal thread 5. The spreader screw 7 may be configured as stud bolt of a length which is shorter than the entire length of the internal thread 5 and positioned in the expansion zone 6 that is defined by the longitudinal slots 3, which means that the expansion zone 6, having a smaller thread diameter than the spreader screw 7, extends at a maximum to the end of the longitudinal slots 3, as shown in particular in FIG. 2, so as to ensure a reliable and effective expansion of the dowel component 1.

As further shown in FIG. 1, the dowel includes a second dowel component 2 for securement of the handle 9b on the opposite side of the door leaf 10. The dowel component 2 has a configuration, which substantially corresponds to the dowel component 1, so that parts corresponding to those of the dowel component 1 are denoted by identical reference numerals and not explained again. The dowel component 2 differs from the dowel component 1 in the provision of a pocket 12, which extends from the leaf-proximal end face of the dowel component 2 at the open side of the handle 9b inwardly in axial direction for receiving a coupling piece 13. The pocket 12 can be fabricated by partially boring out the internal thread 5.

The coupling piece 13 is formed with an internal thread 5a for threaded engagement to the fastening screw 4. Thus, through tightening, the coupling piece 13 is firmly pressed against the associated pane 11 while simultaneously tightening the handle 9a on the opposite side of the door leaf 10 via the fastening screw 4. Subsequently, the dowel component 2 is fixed in place within the handle 9b by rotating the spreader screw 7 from the open side of the handle 9b into the internal thread 5 and ultimately into the expansion zone 6 of smaller thread diameter. The handle 9b with incorporated dowel component 2 is then placed over the coupling piece 13.

As shown in particular in FIG. 3, the coupling piece 13 is formed with a circumferential notch 14 for insertion of set screws 15 (FIG. 1) which are insertable through aligned bores 19 in the wall of the handle 9b and the dowel component 2 to thereby firmly connect the handles 9a, 9b with one another.

In order to realize a particularly high degree of expansion of the dowel, the expansion zone 6 of each of the dowel components 1, 2 has a tapered portion 6a in the direction toward the associated end face of the dowel component. Thus, a further rotation of the spreader screw 7 into the expansion zone 6 results in an added spreading of the dowel components 1, 2. The thread in the tapered portion 6a as well as in the remaining portion of the expansion zone 6 has a pitch which corresponds to the pitch of the thread of the spreader screw 7.

Insertion of the spreader screw 7 into the expansion zone 6 can be facilitated by providing a small part of the internal thread 5 at the base of the pocket 12 for threaded engagement of the spreader screw 7 with same thread diameter before entering the actual expansion zone 6 of smaller diameter.

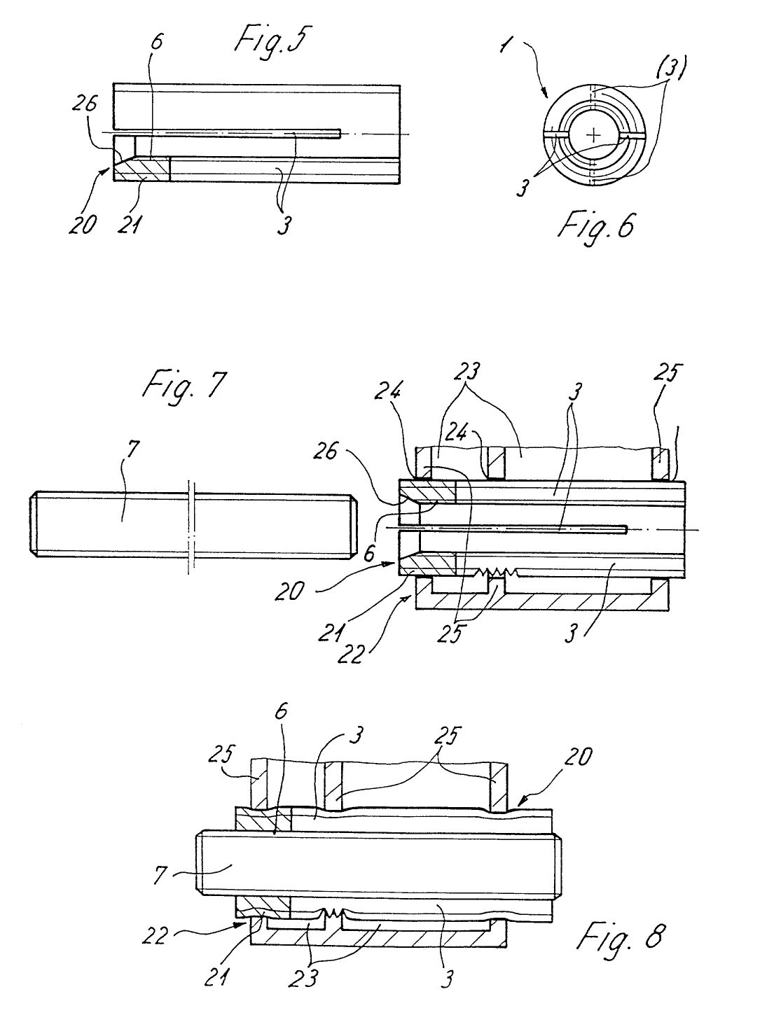

Turning now to FIG. 5, there is shown a partially sectional side view of a half portion of another embodiment of a metallic dowel according to the present invention, generally designated by reference numeral 20 and useful in particular for a fitting for a door or window. Parts corresponding with those in FIG. 1 are denoted by identical reference numerals and not explained again. The dowel 20 is of single-piece configuration and is configured as a cylindrical sleeve with opposite axial ends and a threaded expansion zone 6 which extends along the entire length of the dowel 20 and has a diameter which is smaller throughout its length than the diameter of a spreader screw 7 to be rotated into the threaded expansion zone 6 while the pitch remains the same. Extending inwardly in axial direction from each end are two longitudinal slots 3 in opposite relationship and of a length that reaches near the opposite end region. As best shown in FIG. 6, the longitudinal slots 3 on the opposite ends of the dowel 20 are arranged offset to one another, suitable by 90°.

As the dowel 20 is slotted on both ends, an expansion is implemented as soon as the spreader screw 7 is rotated in the expansion zone 6. Thus, a continuous rotation of the spreader screw 7 into the expansion zone 6 will not result in a conjoint rotation of the dowel 20, as the dowel 20 is pressed against a confronting inside wall of a part to be connected.

When the spreader screw 7 has a thread diameter of, for example, 8 mm, an optimum spreading of the dowel 20 occurs, when the thread diameter of the expansion zone 6 is about 7 mm. This ratio is also appropriate for other thread diameters.

Suitably, the expansion zone 6 has an entry region 26 of a thread diameter which corresponds to the thread diameter of the spreader screw 7 in order to realize an instant engagement when the spreader screw 7 is rotated in. Normally, one or two turns are sufficient here. Basically, both ends of the dowel 20 may be provided with such an entry region 26. This may be advantageous as the dowel 20 can be inserted from both sides. Of course, it is also conceivable to configure the dowel 20 in such a way that the end opposite to the entry region 26 is narrowed, so as to realize a very substantial spreading of this end region, when the spreader screw 7 is advanced beyond the end of the dowel 20, thereby providing an added axial securement. This end may, however, also configured straight, with the diameter corresponding to the minor diameter of the spreader screw 7.

In the embodiment of the dowel 20 of FIG. 5, the spreader screw 7 assumes also the function of the fastening screw 4 as used in the dowel of FIG. 1, provided the spreader screw 7 is sufficiently long to extend beyond the dowel 20.

Referring now to FIG. 7, there is shown a partially sectional, exploded side view of the dowel 20 for use in a hollow section, generally designated by reference numeral 22. The hollow profile 22 includes several hollow chambers 23 which are bounded by spaced-apart walls 25 in parallel relationship. The walls 25 are formed with throughbores 24 for passage of the dowel 20, which is so dimensioned as to extend beyond the end walls 25 of the hollow section 22.

As the spreader screw is rotated into the expansion zone 6, the dowel 20 is spread as a result of the smaller diameter of the expansion zone 26 compared to the diameter of the spreader screw 7, so that the dowel 20 is pressed against the confronting surfaces of the walls 25 in the throughbores 24 and bulge outwards into the hollow chambers 23, as shown in FIG. 8.

In the nonlimiting example of FIG. 7, the dowel 20 is provided along its entire length with an outer thread 21 which is pressed into the intrados of the throughbores 24 by the applied expansion pressure to thereby realize a positive connection between the dowel 20 and the hollow section 22. Thus, in conjunction with the deformation of the dowel 20, an absolutely firm union is established in the remaining portions to prevent an extraction, even when exposed to greatest loads. Of course, the outer thread 21 is shown by way of example only and may be substituted by other profiles of the outer surface of the dowel 20, for example, knurling, fluting or the like.

In the event, the dowel 26 has only one entry region 26, the dowel 20 may be provided with a marking, for example, in the form of a profile, such as a knurling.

While the invention has been illustrated and described as embodied in a spreader dowel, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A dowel, comprising:
a dowel component having at least one longitudinal slot and formed with a cylindrical internal thread; and
a spreader screw for threaded engagement in the internal thread of the dowel component,
wherein the internal thread has at least one expansion zone defined by a thread diameter which is constantly smaller than a thread diameter of the spreader screw, and wherein the expansion zone has a thread pitch which is the same as a thread pitch of the spreader screw.

2. The dowel of claim 1, wherein the spreader screw has a length which is shorter than an overall length of the internal thread.

3. The dowel of claim 1, wherein the spreader screw has a nominal diameter which corresponds to a nominal diameter of the internal thread outside the expansion zone.

4. The dowel of claim 1, wherein the expansion zone is tapered toward an associated end face of the dowel component.

5. The dowel of claim 1, wherein the dowel component has a pocket extending in an axial direction over a major portion of the internal thread outside the expansion zone.

6. The dowel of claim 5, and further comprising a coupling piece for placement in the pocket, wherein the dowel component has at least one threaded bore, extending from outside to the pocket, for treaded engagement of a safety screw which interacts with the coupling piece.

7. The dowel of claim 6, and further comprising a fastening screw for threaded engagement into the coupling piece, wherein the fastening screw has a thread diameter which corresponds to a thread diameter of the internal thread.

8. The dowel of claim 1, wherein the expansion zone extends substantially over an entire length of the dowel component.

9. The dowel of claim 8, wherein the dowel component has opposite ends, each formed with at least one longitudinal slot, wherein the longitudinal slot of one of the ends of the dowel component and the longitudinal slot of the other one of the ends of the dowel component are disposed in offset disposition and partially overlap one another.

10. The dowel of claim 9, wherein each of the ends of the dowel component has two such longitudinal slots.

11. The dowel of claim 10, wherein the longitudinal slots on each side directly oppose one another.

12. The dowel of claim 10, wherein the longitudinal slots are disposed in evenly offset disposition.

13. The dowel of claim 8, wherein the expansion zone has opposite ends, at least one end formed as an entry zone defined by a thread diameter which corresponds to a thread diameter of the spreader screw.

14. The dowel of claim 1, wherein the dowel component has opposite ends, each end including a said expansion zone.

15. The dowel of claim 13, wherein the expansion zone has an end distal to the entry zone, wherein said end of the expansion zone has an inside surface which flares outwards.

16. The dowel of claim 13, wherein the expansion zone has an end distal to the entry zone, wherein said end of the expansion zone has an inside surface which is straight and defined by a diameter which corresponds to a minor diameter of the internal thread.

17. The dowel of claim 13, wherein the dowel component has an outer surface in the area of the entry zone, wherein the outer surface is provided with a profiled marking.

18. The dowel of claim 1, wherein the dowel component has an outer surface formed substantially with an external thread.

19. A dowel, comprising:
a first dowel component having at least one longitudinal slot and formed with an internal thread;
a second dowel component having at least one longitudinal slot and formed with a internal thread;
a fastening screw intended for threaded engagement in the internal thread of the first dowel component and in the internal thread of the second dowel component;
a pair of spreader screws, one spreader screw intended for threaded engagement in the internal thread of the first dowel component, and the other spreader screw intended for threaded engagement in the internal thread of the second dowel component,
wherein the internal thread of each of the first and second dowel components has at least one expansion zone defined by a thread diameter, which is smaller than a thread diameter of the spreader screw, and wherein the expansion zone has a thread pitch which is the same as a thread pitch of the spreader screw.

20. The dowel of claim 19, wherein the expansion zone is tapered at one axial end thereof.

21. The dowel of claim 19, and further comprising a coupling piece, wherein the second dowel component has a pocket extending in an axial direction inwardly of the expansion zone and receiving the coupling piece for interaction with a safety screw to secure the first and second dowel components in place.

22. The dowel of claim 19, wherein each of the first and second dowel component is formed with axial slots to define radially deflectable segments for pressing against a confronting wall of the handles, when the spreader screw is moved into the expansion zone.
